(19) United States
(12) Patent Application Publication
(10) Pub. No.: US 2026/0293868 A1
(43) Pub. Date: Oct. 1, 2026

(54) MOLD APPARATUS AND METHODS OF MAKING WEIGHTED FISHING LURES

(71) Applicant: Epic Bait Molds, Inc., Anderson, SC (US)

(72) Inventor: Jason Kobishop, Anderson, SC (US)

(21) Appl. No.: 19/394,348

(22) Filed: Nov. 19, 2025

Related U.S. Application Data
(60) Provisional application No. 63/780,172, filed on Mar. 29, 2025.

(51) Int. Cl. A01K 85/00; B22D 17/22; B22D 19/04

(52) U.S. Cl. CPC A01K 85/1897; B22D 17/22; B22D 19/04

(57) ABSTRACT

A portable, handheld mold apparatus for making weighted fishing lures with an internal weight molded inside a polymer body is provided. The mold apparatus includes two sets of molds, including a weight mold and a lure mold. The weight mold is used to mold a weight onto a hook or onto a wireform to produce a weighted hook or weighted wireform. The lure mold is designed to receive the weighted hook or weighted wireform within the lure mold and to retain the weighted hook or weighted wireform in a fixed position inside the mold cavity. Polymer material may then be injected into the lure mold so that the polymer surrounds the molded weight that is attached to the hook or wireform to produce a weighted fishing lure.

### CROSS REFERENCES

This application claims the benefit of U.S. Provisional Application No. 63/780,172, filed Mar. 29, 2025, which application is incorporated herein in its entirety by reference.

### FIELD OF THE DISCLOSURE

The present disclosure relates generally to a mold apparatus for making fishing lures, and more particularly to a portable mold apparatus for making weighted fishing lures with an internal weight molded inside a polymer body.

### BACKGROUND

Artificial fishing lures are commonly used by anglers to attract and catch fish. Many fishermen enjoy the process of creating their own lures, as it allows for customization and can be a cost-effective alternative to purchasing pre-made lures. Homemade lures can be crafted from various polymer-based substances that can be molded into desired shapes and sizes. Such polymer materials may be used to make lures of varying hardness, including both soft plastic and hard plastics lures.

The weight of a fishing lure is an important factor in its performance. Weighted lures can help achieve proper casting distance, control the depth at which the lure operates in the water, and influence the lure's action and movement. Some commercially available lures incorporate weights into the body of the lure, providing a balanced and integrated design.

For hobbyists who make lures at home, adding weight to a lure typically involves attaching external weights or inserting weights into pre-formed cavities. However, these methods may not always result in a seamless integration of the weight with the lure body. Additionally, the process of adding weights to homemade lures can be time-consuming and may require multiple steps.

Molds are commonly used by hobbyists to create plastic fishing lures at home. These molds allow for the pouring of liquid polymer materials, which then cure and solidify into the desired lure shape. While various mold designs exist for creating different lure styles, there are limitations in the ability to incorporate internal weights directly during the molding process.

The field of homemade lure creation continues to evolve, with enthusiasts seeking new methods and tools to enhance their lure-making capabilities. Improvements in mold designs and techniques for integrating weights into lures could potentially offer benefits to those who enjoy crafting their own fishing tackle.

### SUMMARY

In one aspect, a portable mold apparatus and a method of using the apparatus to make weighted, molded fishing lures for personal use are provided. The mold apparatus includes multiple mold components, each of which can be handheld by a user for at-home use in making weighted fishing lures that are molded with an integrated internal weight inside the plastic material that forms the body of the lure. Once molded, the plastic material is generally adhered to the internal weight to form an integrated weighted lure. The internal weight may be integrally attached to a hook having a pointed end that extends outside the body of the lure for hooking a fish. In another embodiment, the weight may be integrally attached to a wireform having loops that extend outside the body of the lure to allow one or more hooks to be attached to the loops of the wireform.

The mold apparatus generally comprises two sets of molds, which include a weight mold and a lure mold. The weight mold is used to mold a metal weight into a molded shape and integrally attach the molded weight to an unweighted hook or to an unweighted wireform to produce a weighted hook or a weighted wireform. The lure mold is used to mold a polymer material around the molded weight of the weighted hook or weighted wireform to produce the end product, which is a fishing lure having an internal weight integrated into the polymer body of the lure. The polymer material is also molded around portions of the hook or the wireform. The lure mold is configured to receive the weighted hook or weighted wireform within a lure mold cavity of the lure mold and to retain the weighted hook or weighted wireform in a fixed position within the lure mold cavity before the polymer material is injected into the lure mold cavity. Retaining the weighted hook or weighted wireform in the proper fixed position within the lure mold cavity ensures proper positioning of the weight, as well as other portions of the hook or wireform, within the body of the final molded lure as the polymer material is injected into the lure mold cavity to form the molded shape in which the polymer material surrounds the molded weight of the weighted hook or weighted wireform.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### DESCRIPTION OF THE DRAWINGS

These and other features, aspects, and advantages of the present invention will become better understood with regard to the following description, appended claims, and accompanying drawings where:

FIG. 1 shows a side view of a fishing lure with an integrated weighted hook in accordance with the present disclosure.

FIG. 2 shows a perspective view of a fishing lure with an integrated weighted hook in accordance with the present disclosure.

FIG. 3 shows a side view of a hook that may be utilized to produce a weighted fishing lure in accordance with the present disclosure.

FIG. 4 shows a plan view of two complementary dies of a weight mold in accordance with the present disclosure.

FIG. 5 shows a perspective view of two complementary dies of a weight mold in accordance with the present disclosure.

FIG. 6 shows a partial plan view of a weight mold die with a hook positioned on the die in accordance with the present disclosure.

FIG. 7 shows a side view of a weighted hook with excess weight material after molding in accordance with the present disclosure.

FIG. 8 shows a side view of a weighted hook after molding in accordance with the present disclosure.

FIG. 9 shows a plan view of a die of a lure mold in accordance with the present disclosure.

FIG. 10 shows a plan view of a die of a lure mold in accordance with the present disclosure.

FIG. 11 shows a perspective view of the lure mold die shown in FIG. 10.

FIG. 12 shows a partial plan view of a lure mold die with a weighted hook positioned on the die in accordance with the present disclosure.

FIG. 13 shows a cross-sectional view of the lure mold die with a weighted hook positioned on the die along line 13–13.

FIG. 13A shows a cross-sectional view of the lure mold die with a weighted hook positioned on the die along line 13A–13A.

FIG. 14 shows a side view of a fishing lure with an integrated weighted wireform in accordance with the present disclosure.

FIG. 15 shows a side view of a wireform that may be utilized to produce a weighted fishing lure in accordance with the present disclosure.

FIG. 16 shows a plan view of two complementary dies of a weight mold in accordance with the present disclosure.

FIG. 17 shows a perspective view of two complementary dies of a weight mold in accordance with the present disclosure.

FIG. 18 shows a partial plan view of a weight mold die with a wireform positioned on the die in accordance with the present disclosure.

FIG. 19 shows a side view of a weighted wireform with excess weight material after molding in accordance with the present disclosure.

FIG. 20 shows a side view of a weighted wireform after molding in accordance with the present disclosure.

FIG. 21 shows a plan view of a die of a lure mold in accordance with the present disclosure.

FIG. 22 shows a plan view of a die of a lure mold in accordance with the present disclosure.

FIG. 23 shows a perspective of the lure mold die shown in FIG. 22.

FIG. 24 shows a partial plan view of a lure mold die with a weighted wireform positioned on the die in accordance with the present disclosure.

FIG. 25 shows a cross-sectional view of the lure mold die with a weighted hook positioned on the die along line 25–25.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

In one aspect, a portable mold apparatus and a method of using the apparatus to make weighted, molded fishing lures 10 for personal use are provided. The mold apparatus includes multiple mold components, each of which can be handheld by a user for at-home use in making weighted fishing lures that are molded with an integrated internal weight 22 inside plastic material that forms the body 26 of the lure 10. Once molded, the plastic material is generally adhered to the internal weight 22 to form an integrated weighted lure 10. The mold apparatus comprises separate molds each having molding surfaces with profiles shaped for molding weights 22 and for separately molding lure bodies 26. The profiled molding surfaces may have varying shapes for producing lures 10 of various shapes and sizes. The profiled molding surfaces may also have different configurations depending on the type of lure 10 being produced.

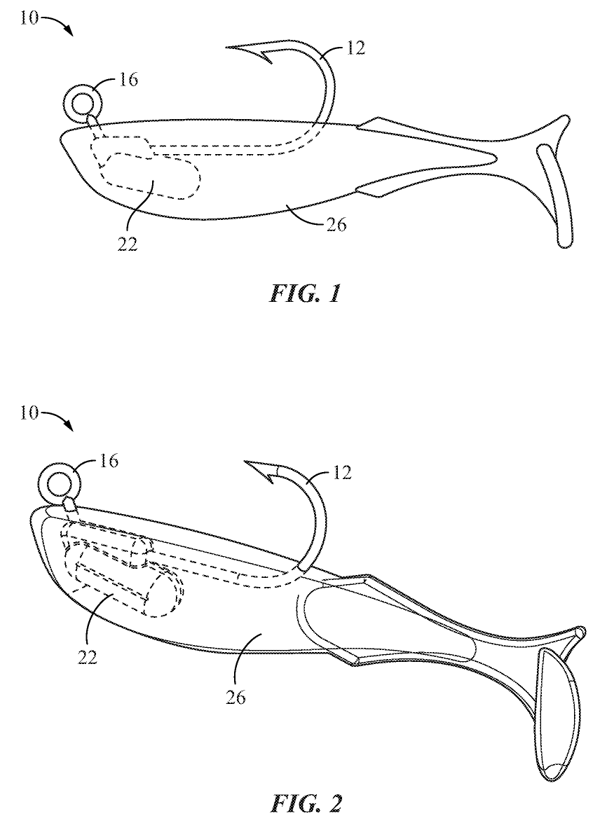

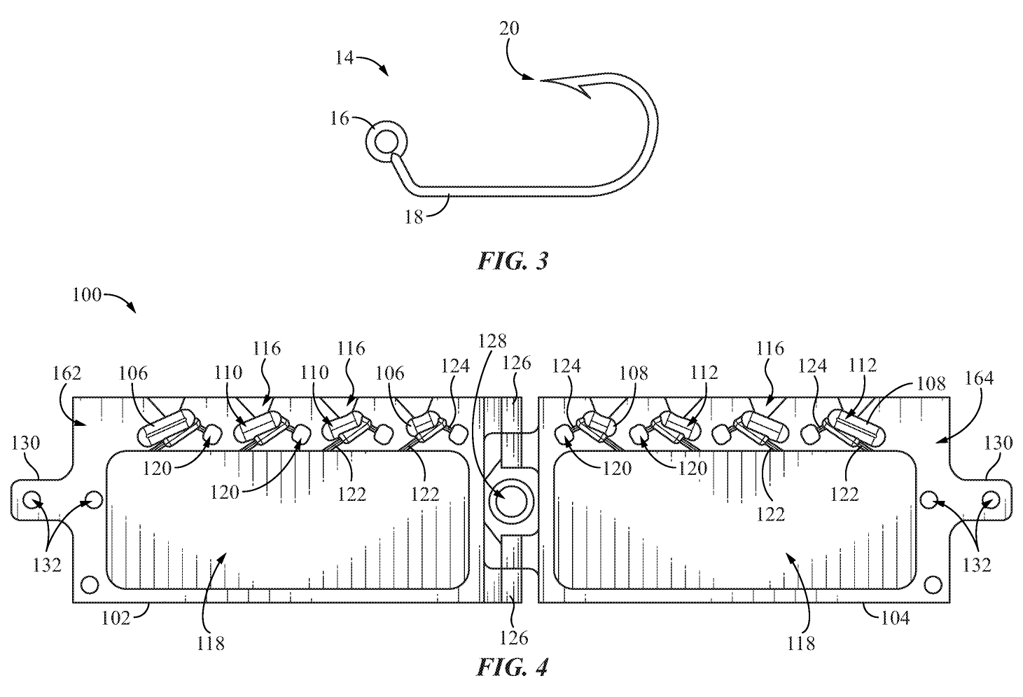

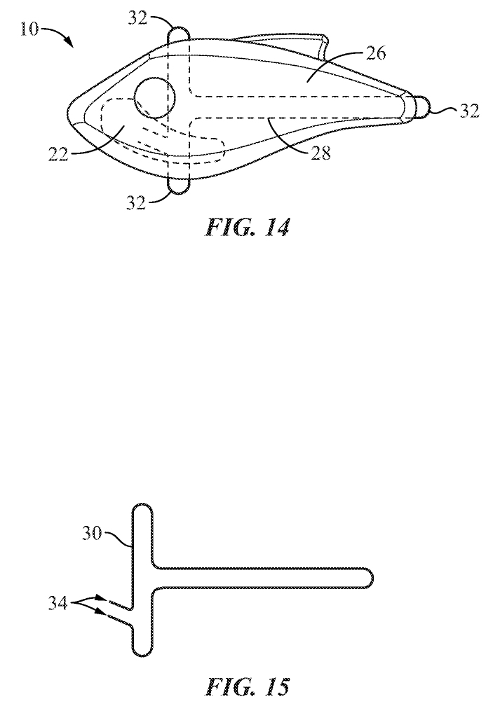

In one embodiment, the molds are configured to produce a lure 10 with a weighted hook 12 integrated into the body 26, as shown in FIGS. 1 and 2. FIGS. 3-13 show components for producing the lure 10 shown in FIGS. 1 and 2. In another embodiment, the molds are configured to produce a lure 10 with a weighted wireform 28 integrated into the body 26, as shown in FIG. 14. FIGS. 15-25 show components for producing the lure 10 shown in FIG. 14. Thus, in one embodiment, the internal weight 22 may be integrally attached to a hook 14 having a pointed end 20 that extends outside the body 26 of the lure 10 for hooking a fish. In another embodiment, the weight 22 may be integrally attached to a wireform 30 having loops 32 that extend outside the body 26 of the lure 10 to allow one or more hooks to be attached to the weighted wireform 28. It should be understood by one of skill in the art that the mold may come in other shapes and configurations to produce various types of molded weighted lures 10 and still fall within the scope of the present disclosure.

The mold apparatus generally comprises two sets of molds, which include a weight mold 100, 300 and a lure mold 200, 400. The weight mold 100, 300 is used to mold a metal weight 22 into a molded shape and integrally attach the molded weight 22 to an unweighted hook 14 or to an unweighted wireform 30 to produce a weighted hook 12 or a weighted wireform 28, respectively, that includes the molded weight 22. The lure mold 200, 400 is used to mold a polymer material around the molded weight 22 of the weighted hook 12 or weighted wireform 28 to produce the end product, which is a fishing lure 10 having an internal weight 22 integrated into the polymer body 26 of the lure 10. The polymer material is also molded around portions of the weighted hook 12 or the weighted wireform 28. The lure mold 200, 400 is configured to receive the weighted hook 12 or weighted wireform 28 within a lure mold cavity of the lure mold and to retain the weighted hook 12 or weighted wireform 28 in a fixed position within the lure mold cavity before the polymer material is injected into the lure mold cavity. Retaining the weighted hook 12 or weighted wireform 28 in the proper fixed position within the lure mold cavity ensures proper positioning of the weight 22, as well as other portions of the weighted hook 12 or the weighted wireform 28, within the body 26 of the final molded lure 10 as the polymer material is injected into the lure mold cavity to form the molded shape in which the polymer material surrounds the molded weight 22 of the weighted hook 12 or weighted wireform 28.

According to an aspect of the present disclosure, a portable mold apparatus for making a weighted fishing lure 10 as shown in FIGS. 1 and 2 is provided. The mold apparatus includes a weight mold 100 defining a weight mold cavity. The weight mold 100 is configured to mold a metal weight 22 onto an unweighted hook 14, as shown in FIG. 3, to form a weighted hook 12 including a molded weight 22 that is integrally attached to the hook, as shown in FIG. 8. The mold apparatus also includes a lure mold 200 defining a lure mold cavity. The lure mold 200 is configured to receive the weighted hook 12 within the lure mold cavity and to mold a polymer material around the molded weight 22 of the weighted hook 12. The lure mold 200 is further configured to retain the weighted hook 12 in a fixed position within the lure mold cavity before and during injection of the polymer material into the lure mold cavity.

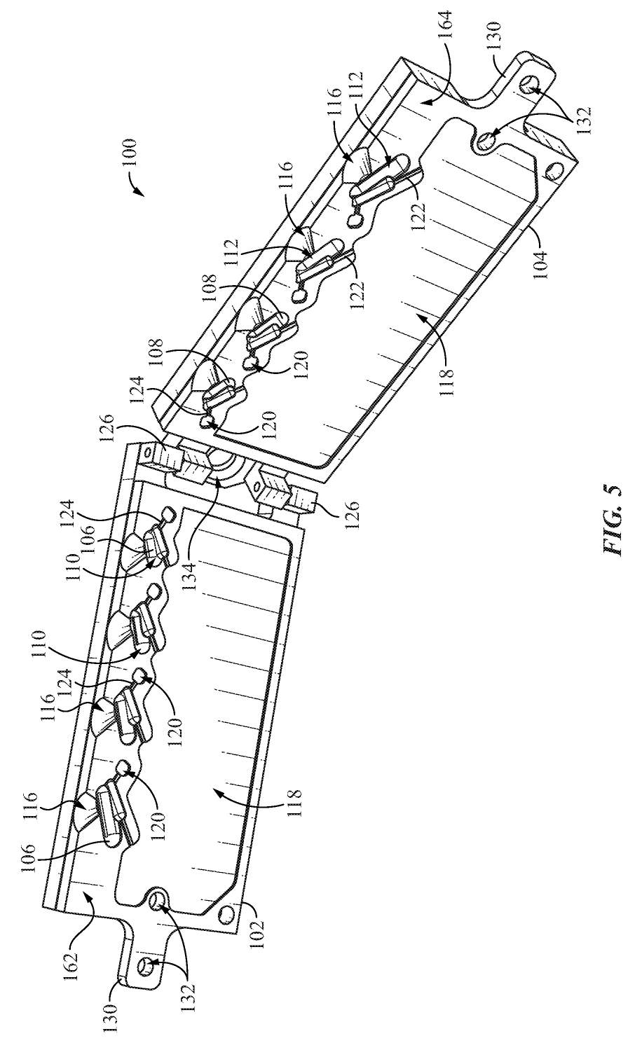

The weight mold 100 comprises a first weight die 102 and a complementary second weight die 104. The first and second weight dies 102 and 104 may be attached to each other by a hinge 126 configured to move the weight mold 100 between an opened position and a closed position. The complementary dies 102 and 104 may each have a handle 130 mounted on each of the dies with the handle 130 being configured to allow a user to manually retain the weight mold 100 in the closed position for molding the weight 22 onto the unweighted hook 14 to form the weighted hook 12. The handles 130 and/or other portions of dies 102 and 104 may have openings 132 extending therethrough for mounting handle extensions (not shown) to allow the user to more easily move the weight mold 100 between the opened and closed positions and hold the weight mold 100 in the closed position when molding. In a preferred embodiment, the hinge 126 may comprise a stopper 134 configured to limit pivotal rotation of the first weight die 102 relative to the complementary second weight die 104 such that the first weight die 102 and the complementary second weight die 104 are generally at a 180-degree angle to each other when the weight mold 100 is in the fully opened position, as shown in FIG. 4. The stopper 134 may be attached to one die, which in this case is die 104, and may contact the opposing die, which in this case is die 102, to stop pivotal rotation of the dies. FIG. 5 shows dies 102 and 104 partially rotated relative to each other about the hinge 126 so that the weight mold 100 is in a partially closed position. The hinge 126 preferably also includes an opening 128 that may allow the user to hang the weight mold 100 for storage when not in use.

The first weight die 102 has a first weight surface 106 that defines a first weight cavity 110, and the second weight die 104 has a second weight surface 108 that defines a second weight cavity 112. In addition, the first weight die 102 has an outer face 162 having a generally flat surface, and the second weight die 104 also has an outer face 164 having a generally flat surface. The weight surfaces 106 and 108, as well as relief areas, flow channels, and vent channels are all defined by profiled indentations in outer faces 162 and 164, respectively. The weight mold cavity for molding each weight 22 is defined by the first weight cavity 110 and the second weight cavity 112 when the first weight die 102 and the complementary second weight die 104 are engaged in face sharing contact with each other, which may be done by pivoting the dies 102 and 104 toward each other about the hinge 126 to move the weight mold 100 into the closed position in which faces 162 and 164 are in direct contact with each other. The first weight die 102 and the complementary second weight die 104 further define a liquid metal flow channel 116 that fluidly connects the weight mold cavity to an opening on an exterior of the weight mold 100 when the weight mold 100 is closed. As shown in FIGS. 4 and 5, each die 102 and 104 may have four sets of complementary cavities 110 and 112 so that up to four weighted hooks 12 may be produced simultaneously in a single molding step. Each set of cavities 110 and 112 may optionally be configured to produce weights 22 of different sizes to produce lures 10 having varying weights. It should be understood that the number of sets of cavities may be changed and still fall within the scope of the present disclosure.

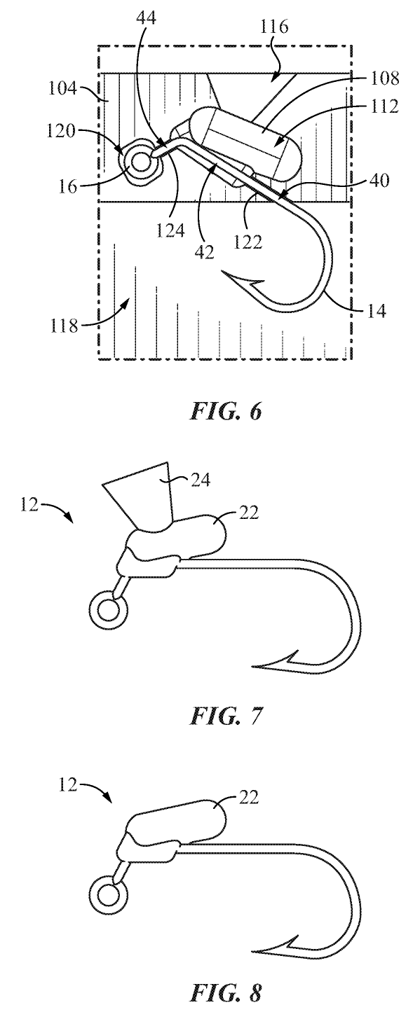

The first weight surface 106 includes a first hook channel 122 extending from the first weight cavity 110, and the second weight surface 108 includes a second hook channel 122 extending from the second weight cavity 112. As shown in FIG. 6, the first hook channel 122 and the second hook channel 122 are configured to receive a first portion 40 of the unweighted hook 14 therein when the first weight die 102 and the complementary second weight die 104 are engaged in face sharing contact with each other so that a second portion 42 of the hook 14 extends into the weight mold cavity. As shown in FIGS. 4 and 5, each weight die 102 and 104 may also have a hook point relief area 118 configured to receive the pointed end 20 of the unweighted hook 14, as best seen in FIG. 6. The hook point relief area 118 may be defined by an indentation in the outer faces 162 and 164 that covers a generally large area in which portions of the hook 14 may be disposed during molding of the weight 22 onto other portions of the hook 14. The first portion 40 of the unweighted hook 14 may be a portion of a shank 18 of the hook 14 that extends through the hook channel 122 and into the relief area 118, which may provide space sufficient to hold hooks of varying sizes. The second portion 42 of the unweighted hook 14 may be a different portion of the shank 18 to which the molded weight 22 becomes integrally attached after molding. Each weight die 102 and 104 may also have a hook eye relief area 120 configured to receive an eye 16 of the hook 14 therein. A separate channel 124 may connect the hook eye relief area 120 to the weight cavity and may receive a portion 44 of the hook 14 near the eye 16.

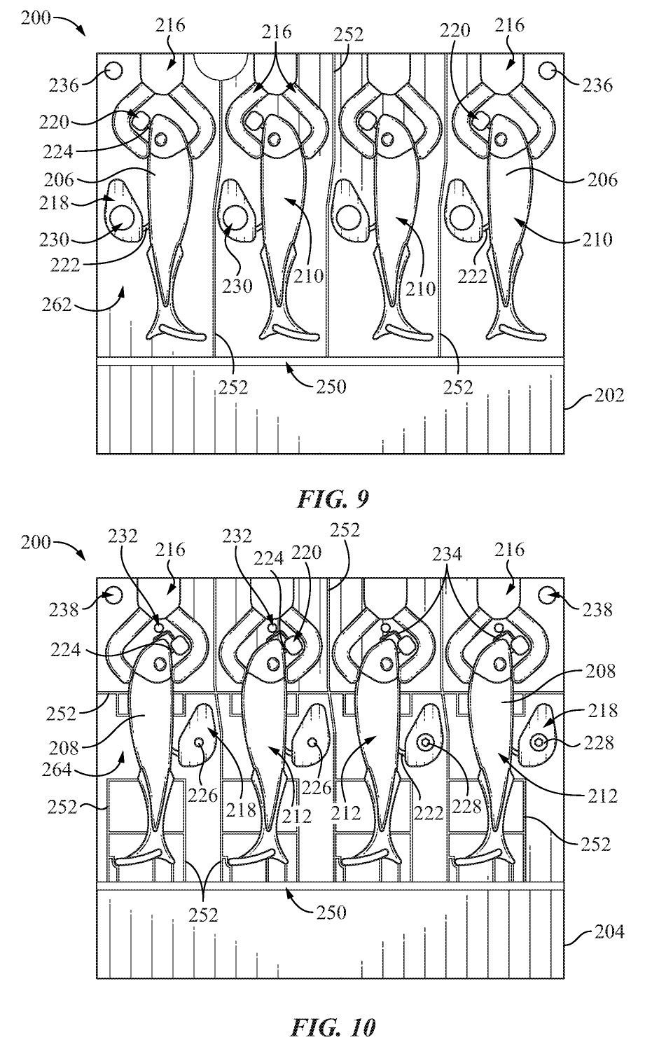

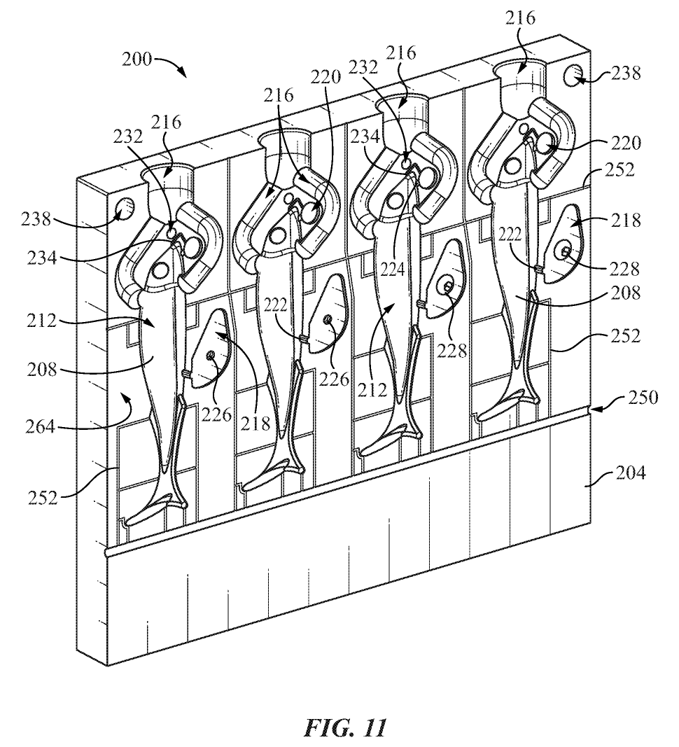

As shown in FIGS. 9 and 10, the lure mold 200 comprises a first lure die 202 and a complementary second lure die 204. FIG. 11 shows a perspective view of second lure die 204. The first lure die 202 has a first lure surface 206 that defines a first lure cavity 210, and the second lure die 204 has a second lure surface 208 that defines a second lure cavity 212. In addition, the first lure die 202 has an outer face 262 having a generally flat surface, and the second lure die 204 also has an outer face 264 having a generally flat surface. The lure surfaces 206 and 208, as well as relief areas, flow channels, and vent channels are all defined by profiled indentations in outer faces 262 and 264, respectively. The lure mold cavity is defined by the first lure cavity 210 and the second lure cavity 212 when the first lure die 202 and the complementary second lure die 204 are engaged in face sharing contact with each other when faces 262 and 264 are in direct contact with each other. The first lure die 202 and the complementary second lure die 204 further define a polymer flow channel 216 that fluidly connects the lure mold cavity to an opening on an exterior of the lure mold 200.

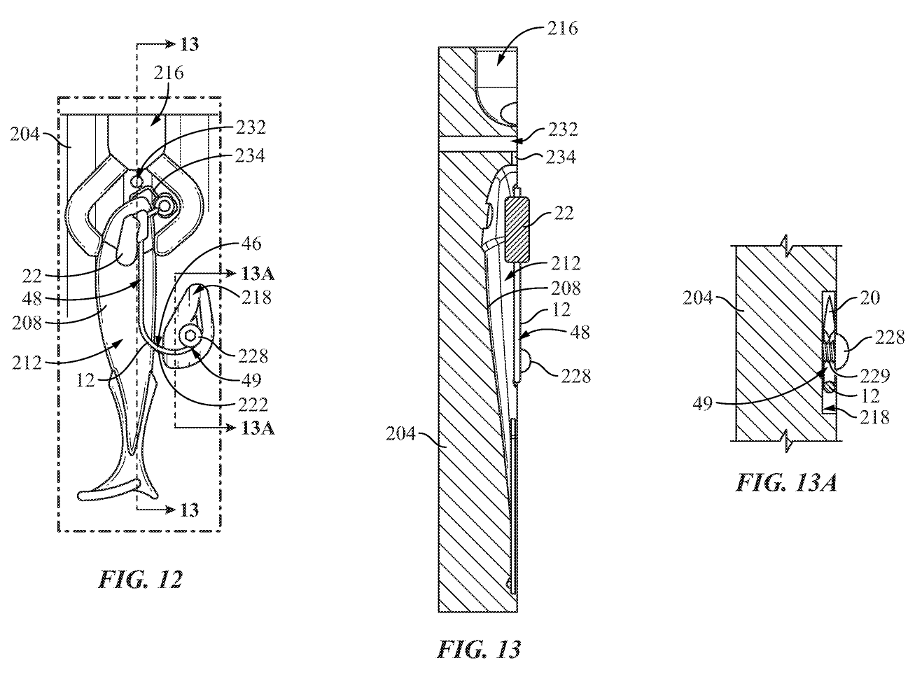

The first lure surface 206 includes a third hook channel 222 extending from the first lure cavity 210, and the second lure surface 208 includes a fourth hook channel 222 extending from the second lure cavity 212. The third hook channel 222 and the fourth hook channel 222 are configured to receive a first portion 46 of the weighted hook 12 therein when the first lure die 202 and the complementary second lure die 204 are engaged in face sharing contact with each other so that a second portion 48 of the weighted hook 12 extends into the lure mold cavity, as shown in FIG. 12. Each lure die 202 and 204 may also have a hook point relief area 218 configured to receive the pointed end 20 of the weighted hook 12 therein. The hook point relief area 218 may be defined by an indentation in the outer faces 262 and 264 that covers a generally large area in which portions of the weighted hook 12 may be disposed during molding of the body 26 of the lure 10 around the weight 22 and other portions of the weighted hook 12. The first portion 46 of the weighted hook 12 may extend through hook channel 222 and into the relief area 218, which provides space to hold portions of the weighted hook 12 that will be external to the body 26 of the lure 10. Thus, hook channel 222 may extend between the hook point relief area 218 and each lure cavity. The hook point relief area 218 may provide space sufficient to hold hooks of varying sizes.

As shown in FIGS. 10-13 and 13A, the lure mold 200 further comprises a hook retainer 228 configured to retain the weighted hook 12 in a fixed position within the lure mold cavity when the first lure die 202 and the complementary second lure die 204 are engaged in face sharing contact with each other. In a preferred embodiment, the hook retainer comprises a retaining member 229 extending outwardly from a surface of the hook point relief area 218 and a head 228 extending radially outward from the retaining member 229 to define a space disposed between the surface of the hook point relief area 218 and the head 228 of the hook retainer. The space between the surface of the hook point relief area 218 and the head 228 is sized to receive a third portion 49 of the weighted hook 12 therein to securely retain the weighted hook 12 in place during the molding process. In one preferred embodiment, the hook retainer 228 comprises a fastener 228 that can be removably secured to one lure die 204 and that is configured to removably secure the pointed end 20 of the weighted hook 12 in a fixed position within the hook point relief area 218. Preferably, the fastener 228 is a threaded bolt having a shank 229 with male threads, and the hook point relief area 218 has a threaded opening 226 with female threads that are compatible with the male threads of the fastener shank 229. In a preferred embodiment, the lure surface 206 of the opposing lure die 202 further includes a bolt head relief area 230 configured to receive a head of the bolt 228 therein. Securing the weighted hook 12 in a fixed position within the lure mold cavity ensures proper positioning of the weight 22, as well as other portions of the hook 12 (or wireform 28), within the lure mold cavity and thus within the body 26 of the lure 10 after molding.

When preparing the lure dies 202 and 204 for molding, the weighted hook 12 (including both the hook portion and molded weight 22 attached thereto) is first placed into lure die 204 in the proper position, as shown in FIG. 12. Each lure die 202 and 204 may also have a hook eye relief area 220 configured to receive the eye 16 of the weighted hook 12 therein. A separate channel 224 may connect the hook eye relief area 220 to the lure cavity and may receive a portion 44 of the weighted hook 12 near the eye 16. When the weighted hook 12 is placed into channels 222 and 224, the mass of weight 22 may initially cause the weighted hook 12 to move out of its proper position while the user is arranging the lure dies 202 and 204 in their proper positions for molding, particularly if lure die 204 is in a horizontal position when placing the weighted hook 12 onto the lure die 204. The fastener 228 retains the weighted hook 12 in the proper position throughout the entire process so that the weighted hook 12 cannot move out of position at any time during the molding process.

To removably secure the weighted hook 12 in a fixed position, lure die 204 may be configured such that a portion of the weighted hook 12 disposed within the hook point relief area 218 is disposed adjacent to threaded opening 226. Fastener 228 may then be threaded into the opening 226 until the head 228 of the bolt contacts a portion 49 of the weighted hook 12 to retain the hook in place. After molding, the fastener 228 may be partially unthreaded or entirely removed to release the weighted hook 12 from the lure mold 200. FIGS. 10 and 11 show lure mold 204 with two of the four individual mold cavities having bolts 228 threaded into openings 226 and the remaining two individual mold cavities showing threaded openings 226 without bolts 228. The head 228 of each bolt preferably has a circular shape, as best seen in FIG. 12, and may have a hex-shaped recess for engaging the head 228 to thread the bolt. Alternatively, in one embodiment, the hook retainer 228 may be permanently attached to lure die 204 in a fixed position so that the hook retainer 228 is not adjustable by the user. In such a case, the hook retainer 228 may be designed to retain hooks 12 of a particular size or range of sizes within a certain tolerance of hook diameter. The space between the surface of the hook point relief area 218 and the head 228 may be sized to form a transition fit with the weighted hook 12 when a portion 49 of the hook is inserted into the space. The transition fit may be a clearance fit with a small gap between the hook 12 and the retainer head 228 and/or surface 218 or an interference fit in which the user presses the hook 12 into the space to retain the hook. FIGS. 13 and 13A show cross-sectional views of lure mold 204 with a weighted hook 12 retained in the proper position using a threaded bolt 228. As shown in FIG. 13, the molded weight 22 remains in a centered position within the lure mold cavity and is not offset from the centerline toward the second lure surface 208, which results in the weight 22 being laterally centered within the body 26 of the lure 10 so that the overall weight of the lure 10 is balanced.

According to another aspect of the present disclosure, a method of molding a weighted fishing lure 10 as shown in FIGS. 1 and 2 is provided. The method includes providing the portable mold apparatus as described above for making a weighted fishing lure 10. The method further includes positioning the first portion 40 of the unweighted hook 14 within the first hook channel 122, engaging the first weight die 102 and the second weight die 104 in face sharing contact to form the weight mold cavity so that the second portion 42 of the unweighted hook 12 extends into the weight mold cavity, injecting a liquid metal into the weight mold cavity through the liquid metal flow channel 116 and allowing the liquid metal to cool and harden to form the weighted hook 12, and then removing the weighted hook 12 from the weight mold 100. The liquid metal is preferably lead but may comprise any other metal suitable to be heated and molded into a shape defined by the weight molds 102 and 104. As shown in FIG. 7, when the weighted hook 12 is removed from the mold, it may have a portion of excess weight 24, which can be cut off to produce the weighted hook 12 as shown in FIG. 8.

The method further comprises positioning the first portion 46 of the weighted hook 12 within the third hook channel 222, removably securing the weighted hook 12 in a fixed position relative to lure die 204, engaging the first lure die 202 and the second lure die 204 in face sharing contact to form the lure mold cavity so that the second portion 48 of the weighted hook 12 extends into the lure mold cavity, injecting a polymer into the lure mold cavity through the polymer flow channel 216 and allowing the polymer to cure and harden to form the weighted fishing lure 10 with the molded weight 22 and other portions of the weighted hook 12 disposed within an interior of the body 26 of the fishing lure 10, and then removing the weighted fishing lure 10 from the lure mold 200. The polymer is preferably plastisol, silicone, or a resin, but the polymer may include any other polymer suitable for molding. The hook retainer 228 may be utilized to removably secure the weighted hook 12 in a fixed position relative to lure die 204. To engage the first lure die 202 and the second lure die 204 in face sharing contact with each other in the proper position to form the lure mold cavity, lure die 202 may have pegs 236 extending outwardly from surface 262 of lure die 202, and lure die 204 may have corresponding recesses 238 configured to receive the pegs 236 to align lure cavities 210 and 212 of the lure dies 202 and 204, respectively, in the proper position for the molding process.

In a preferred embodiment, at least one lure die 204 may have a vent opening 232 extending entirely through the lure die 204, as best seen in FIG. 13. The vent opening 232 is disposed adjacent to an upper end of the lure cavity 212 when the lure die 204 is in an upright vertical position, as shown in FIG. 10. A vent channel 234 fluidly connects the lure cavity 212 to the vent opening 232. This allows any material contained within the lure mold cavity to vent through the vent channel 234 and the vent opening 232. Thus, any air trapped in the upper portions of the cavity 212 when the lure die 204 is in an upright position for injecting the polymer into the cavity 212 to exit the cavity 212 through the vent channel 234 and vent opening 232 without interfering with the flow of polymer into the mold cavity through the polymer flow channel 216, which may split into two separate channels that enter the lure mold cavity on opposing sides of the lure mold cavity, as shown in FIG. 10. As shown in FIGS. 9-11, each lure die 202 and 204 may also include a common vent line 250 and a plurality of additional vent lines 252 that are connected to the common vent line 250 to allow air to exit the lure mold 200 and also to receive any excess polymer material injected into the lure mold cavity, which can be trimmed from the lure 10 after completion of the molding process.

According to another aspect of the present disclosure, a portable mold apparatus for making a weighted fishing lure 10 as shown in FIG. 14 is provided. The mold apparatus includes a weight mold 300 defining a weight mold cavity. The weight mold 300 is configured to mold a metal weight 22 onto an unweighted wireform 30, as shown in FIG. 15, to form a weighted wireform 28 including a molded weight 22, as shown in FIG. 20. The mold apparatus also includes a lure mold 400 defining a lure mold cavity. The lure mold 400 is configured to receive the weighted wireform 28 within the lure mold cavity and to mold a polymer material around the molded weight 22 of the weighted wireform 28. The lure mold 400 is further configured to retain the weighted wireform 28 in a fixed position within the lure mold cavity before and during injection of the polymer material into the lure mold cavity.

FIG. 15 shows an unweighted wireform 30, which generally comprises one or more lengths of wire formed into a shape. The embodiment shown in FIG. 15 comprises a single continuous piece of wire have two terminal ends 34, which may be molded into the interior of the molded weight 22 so that the combination of the weight 22 and length of wire forms a weighted wireform 28 having a closed shape. Alternatively, the wireform may comprise multiple lengths of wire or a single length that forms a closed loop. The weighted wireform 28 has a shape configured to allow the body 26 of the lure 10 to be molded around the weighted wireform 28 with portions of the weighted wireform 28 extending outside the body 26 of the lure 10, as shown in FIG. 14, to form rings or loops 32 for attaching hooks to the lure 10 or for tying fishing line to the lure 10. In a preferred embodiment, the weighted wireform 28 includes at least two loops 32 and preferably includes three loops 32, which may include one loop 32 for tying fishing line to the loop 32 and two loops 32 for attaching hooks thereto.

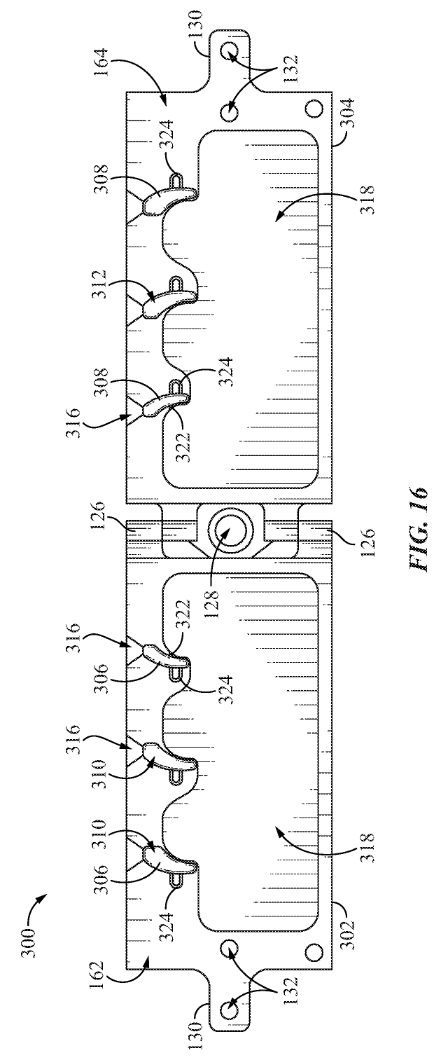

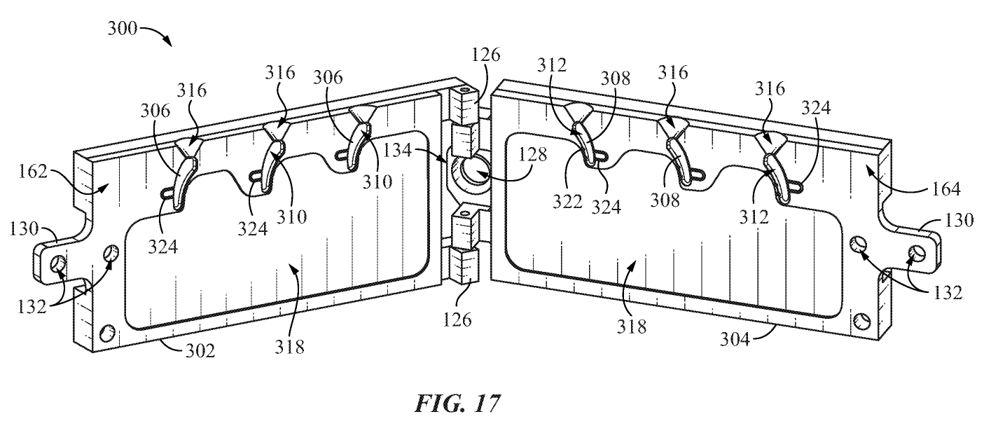

As shown in FIG. 16, the weight mold 300 comprises a first weight die 302 and a complementary second weight die 304. The first weight die 302 has a first weight surface 306 that defines a first weight cavity 310, and the second weight die 304 has a second weight surface 308 that defines a second weight cavity 312. In addition, the first weight die 302 has an outer face 162 having a generally flat surface, and the second weight die 304 also has an outer face 164 having a generally flat surface. The weight surfaces 306 and 308, as well as relief areas, flow channels, and vent channels are all defined by profiled indentations in outer faces 162 and 164, respectively. The weight mold cavity for molding each weight 22 is defined by the first weight cavity 310 and the second weight cavity 312 when the first weight die 302 and the complementary second weight 304 die are engaged in face sharing contact with each other, which may be done by pivoting the dies 302 and 304 toward each other about the hinge 126 to move the weight mold 300 into the closed position in which faces 162 and 164 are in direct contact with each other. FIG. 17 shows dies 102 and 104 partially rotated relative to each other about the hinge 126 so that the weight mold 300 is in a partially closed position. The first weight die 302 and the complementary second weight die 304 further define a liquid metal flow channel 316 that fluidly connects the weight mold cavity to an opening on an exterior of the weight mold 300 when the weight mold 300 is closed.

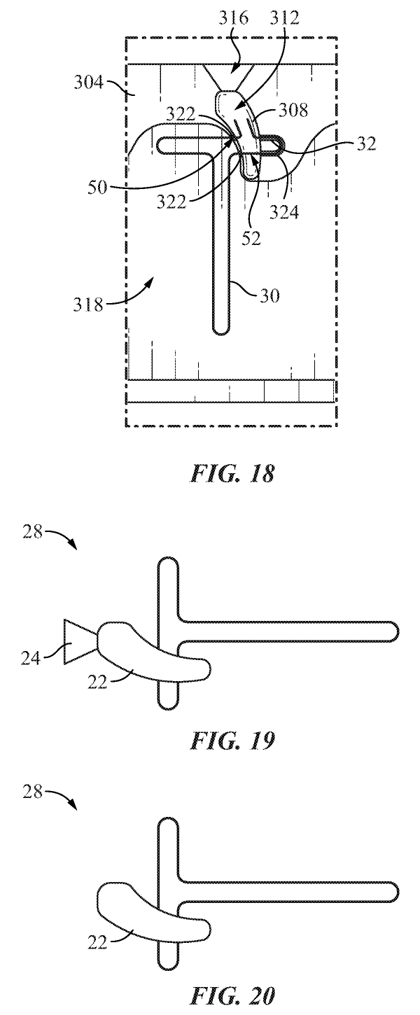

The first weight surface 306 includes a first wire channel 324 extending from the first weight cavity 310, and the second weight surface 308 includes a second wire channel 324 extending from the second weight cavity 312. The first wire channel 324 and the second wire channel 324 are configured to receive a first portion 32 of the unweighted wireform 30 therein so that a second portion 52 of the unweighted wireform 30 extends into the weight mold cavity, as best seen in FIG. 18. In a preferred embodiment, channel 324 is configured to receive a portion of the unweighted wireform 30 that generally forms one of the loops 32 that extends outside the body 26 of the lure 10. Each weight die 302 and 304 preferably include a wireform relief area 318 configured to receive portions of the unweighted wireform 30 that are not disposed within channel 324 or within the weight mold cavity. Each weight die 302 and 304 may also have short channels 322 that connect the wireform relief area 318 to weight cavities 310 and 312, and portions 50 of the unweighted wireform 30 may be received within channels 322 when placing the unweighted wireform 30 into either weight die 302 or 304. These short channels 322 may isolate the wireform relief area 318 from the weight mold cavity so that liquid metal does not flow into the wireform relief area 318 during the molding process.

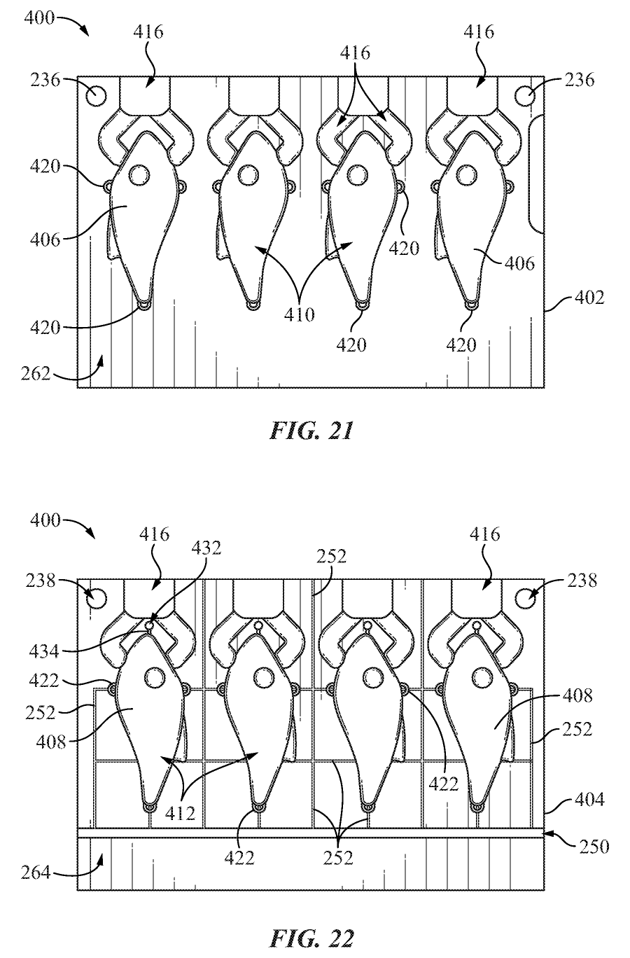

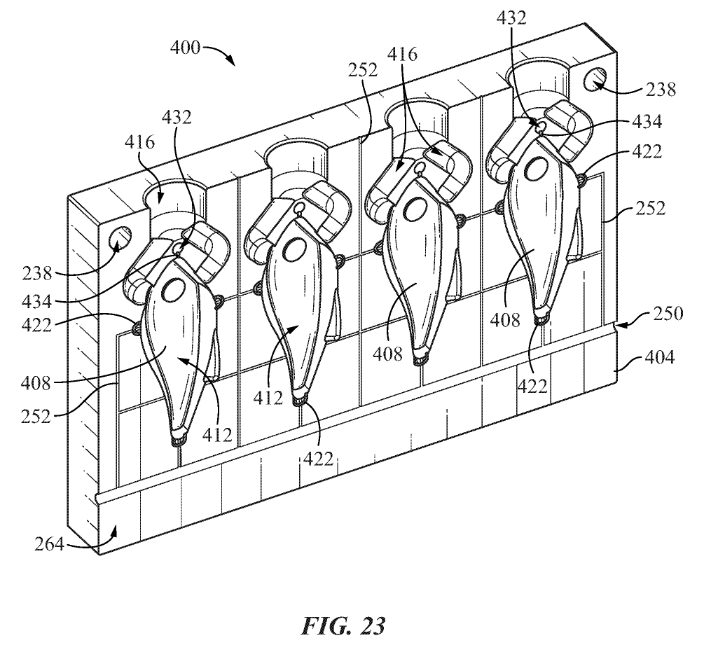

The lure mold 400 comprises a first lure die 402 and a complementary second lure die 404, as shown in FIGS. 21 and 22. FIG. 23 shows a perspective view of second lure die 404. The first lure die 402 has a first lure surface 406 that defines a first lure cavity 410, and the second lure die 404 has a second lure surface 408 that defines a second lure cavity 412. In addition, the first lure die 402 has an outer face 262 having a generally flat surface, and the second lure die 404 also has an outer face 264 having a generally flat surface. The lure surfaces 406 and 408, as well as relief areas, flow channels, and vent channels are all defined by profiled indentations in outer faces 262 and 264, respectively. The lure mold cavity is defined by the first lure cavity 410 and the second lure cavity 412 when the first lure die 402 and the complementary second lure die 404 are engaged in face sharing contact with each other when faces 262 and 264 are in direct contact with each other. The first lure die 402 and the complementary second lure die 404 further define a polymer flow channel 416 that fluidly connects the lure mold cavity to an opening on an exterior of the lure mold 400.

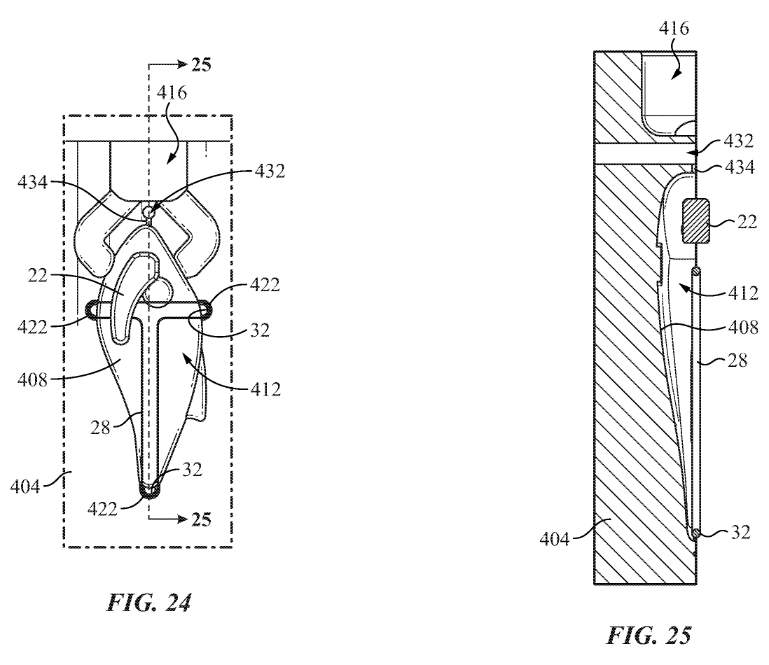

The first lure surface 406 includes a first plurality of wire retaining channels 420 extending from the first lure cavity 410, and the second lure surface 408 includes a second plurality of corresponding wire retaining channels 422 extending from the second lure cavity 412. The first plurality of wire retaining channels 420 and the second plurality of wire retaining channels 422 are configured to receive respective retaining portions 32, which are preferably defined by the portions of the weighted wireform 28 that form rings 32 extending outside the body 26 of the lure 10, of the weighted wireform 28 therein so that the weighted wireform 28 extends from each of the first and second pluralities of wire retaining channels 420 and 422 into the lure mold cavity. Each of the wire retaining channels 420 and 422 thus preferably form a loop channel that extends from the first or second lure cavity 410 or 412, respectively, and back to the first or second lure cavity 410 or 412, respectively. Thus, each loop channel is connected to one of the lure cavities 410 or 412 at two ends of the loop channel. The first and second pluralities of wire retaining channels 420 and 422 are configured to retain the weighted wireform 28 in a fixed position within the lure mold cavity when the first lure die 402 and the complementary second lure die 404 are engaged in face sharing contact with each other For instance, when the weighted wireform 28 is positioned on lure die 404, as shown in FIGS. 24 and 25, the loop rings 32 being positioned with the wire retaining channels 422 at multiple points around the lure cavity 412 retain the weighted wireform 28 in a fixed position relative to die 404, which ensures that the weighted wireform 28 will remain in the proper position within the lure mold cavity throughout the molding process. As best seen in FIG. 25, the molded weight 22 remains in a centered position within the lure mold cavity and is not offset from the centerline toward the second lure surface 408, which results in the weight 22 being laterally centered within the body 26 of the lure 10 so that the overall weight of the lure 10 is balanced.

In a preferred embodiment, at least one lure die 404 may have a vent opening 432 extending entirely through the lure die 404, as best seen in FIG. 25. The vent opening 432 is disposed adjacent to an upper end of the lure cavity 412 when the lure die 404 is in an upright vertical position, as shown in FIG. 22. A vent channel 434 fluidly connects the lure cavity 412 to the vent opening 432. This allows any material contained within the lure mold cavity to vent through the vent channel 434 and the vent opening 432. Thus, any air trapped in the upper portions of the cavity 412 when the lure die 404 is in an upright position for injecting the polymer into the cavity 412 to exit the cavity 412 through the vent channel 434 and vent opening 432 without interfering with the flow of polymer into the mold cavity through the polymer flow channel 416, which may split into two separate channels that enter the lure mold cavity on opposing sides of the lure mold cavity, as shown in FIG. 22. As shown in FIGS. 22 and 23, at least one lure die 404 may also include a common vent line 250 and a plurality of additional vent lines 252 that are connected to the common vent line 250 to allow air to exit the lure mold 400 and also to receive any excess polymer material injected into the lure mold cavity, which can be trimmed from the lure 10 after completion of the molding process.

According to another aspect of the present disclosure, a method of molding a weighted fishing lure 10 as shown in FIG. 14 is provided. The method includes providing the portable mold apparatus as described above for making a weighted fishing lure 10. The method further includes positioning portions 50 and 32 of the unweighted wireform 30 within wire channels 322 and 324, respectively, engaging the first weight die 302 and the second weight die 304 in face sharing contact to form the weight mold cavity so that portion 52 of the unweighted wireform 30 extends into the weight mold cavity, injecting a liquid metal into the weight mold cavity through the liquid metal flow channel 316 and allowing the liquid metal to cool and harden to form the weighted wireform 28, and then removing the weighted wireform 28 from the weight mold 300. The liquid metal is preferably lead but may comprise any other metal suitable to be heated and molded into a shape defined by the weight molds 302 and 304. As shown in FIG. 19, when the weighted wireform 28 is removed from the mold, it may have a portion of excess weight 24, which can be cut off to produce the weighted wireform 28 as shown in FIG. 20.

The method further comprises positioning the loop portions 32 of the weighted wireform 28 within the wire retaining channels 422 to retain the weighted wireform 28 in a fixed position relative to lure die 404, engaging the first lure die 402 and the second lure die 404 in face sharing contact to form the lure mold cavity so that the weighted wireform 28 extends into the lure mold cavity, injecting a polymer into the lure mold cavity through the polymer flow channel 416 and allowing the polymer to cure and harden to form the weighted fishing lure 10 with the molded weight 22 and other portions of the weighted wireform 28 disposed within an interior of the body 26 of the fishing lure 10, and then removing the weighted fishing lure 10 from the lure mold 400. The polymer is preferably plastisol, silicone, or a resin, but the polymer may include any other polymer suitable for molding. To engage the first lure die 402 and the second lure die 404 in face sharing contact with each other in the proper position to form the lure mold cavity, lure die 402 may have pegs 236 extending outwardly from surface 262 of lure die 402, and lure die 404 may have corresponding recesses 238 configured to receive the pegs 236 to align lure cavities 410 and 412 of the lure dies 402 and 404, respectively, in the proper position for the molding process.

In an alternative embodiment, the first weight cavity 110, 310 and the complementary second weight cavity 112, 312 that define the weight mold cavity, as well as the first lure cavity 210, 410 and the complementary second lure cavity 212, 412 that define the lure mold cavity, may be incorporated into a single set of complementary dies rather than two separate sets of complementary dies (such as weight dies 102 and 104 and lure dies 202 and 204 or weight dies 302 and 304 and lure dies 402 and 404, depending on the embodiment) with the single set of dies being used both for molding the weight 22 and for molding the body 26 of the lure 10, respectively. In this embodiment, the user may use the single set of complementary dies to first mold the weight 22 onto the unweighted hook 14 or unweighted wireform 30. After molding the weight 22, the user may then use the same set of complementary dies to also mold the body 26 of the lure 10 onto the weighted hook 12 or weighted wireform 28 . In other embodiments, a single set of complementary dies may include more than two different types of mold cavities having different configurations for molding different types and/or different sizes of weights and/or plastic lures within the single set of complementary dies rather than using multiple sets of dies. It should be understood by one of skill in the art that a single set of complementary dies may include any number of individual mold cavities for molding weighted hooks 12, weighted wireforms 28, and/or plastic lures 10 and still fall within the scope of the present disclosure.

In a preferred embodiment, all of the mold dies 202, 204, 402, 404 are designed to be portable and handheld by an individual user for producing small batches of weighted lures 10 for personal use. In a preferred embodiment, the present apparatus does not include any type of actuators or automated machinery, and the entire molding process is performed manually be the individual user, including steps of hook or wireform placement, engaging the dies with each other, and injecting the liquid metal and polymer material into the appropriate mold 100, 200, 300, 400. The dies may include handles for holding the dies in an engaging position, or the apparatus may include clamps or similar devices for holding the dies together during the molding process.

It will be appreciated that the configurations and methods shown and described herein are illustrative only, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein. It is understood that versions of the invention may come in different forms and embodiments. Additionally, it is understood that one of skill in the art would appreciate these various forms and embodiments as falling within the scope of the invention as disclosed herein.

What is claimed is:

1.) A portable mold apparatus for making a weighted fishing lure, said mold apparatus comprising:
a weight mold defining a weight mold cavity, wherein the weight mold is configured to mold a metal weight onto an unweighted hook to form a weighted hook including a molded weight; and
a lure mold defining a lure mold cavity, wherein the lure mold is configured to receive the weighted hook within the lure mold cavity and to mold a polymer material around the molded weight of the weighted hook,
wherein the weight mold comprises a first weight die and a complementary second weight die, wherein the first weight die has a first weight surface that defines a first weight cavity, wherein the second weight die has a second weight surface that defines a second weight cavity, wherein the weight mold cavity is defined by the first weight cavity and the second weight cavity when the first weight die and the complementary second weight die are engaged in face sharing contact with each other, wherein the weight mold includes a liquid metal flow channel that fluidly connects the weight mold cavity to an opening on an exterior of the weight mold,
wherein the weight mold further includes a first hook channel extending from the first weight cavity, wherein the first hook channel is configured to receive a first portion of the unweighted hook therein so that a second portion of the unweighted hook extends into the weight mold cavity when the first weight die and the complementary second weight die are engaged in face sharing contact with each other,
wherein the lure mold comprises a first lure die and a complementary second lure die, wherein the first lure die has a first lure surface that defines a first lure cavity, wherein the second lure die has a second lure surface that defines a second lure cavity, wherein the lure mold cavity is defined by the first lure cavity and the second lure cavity when the first lure die and the complementary second lure die are engaged in face sharing contact with each other, wherein the lure mold includes a polymer flow channel that fluidly connects the lure mold cavity to an opening on an exterior of the lure mold,
wherein the lure mold further includes a second hook channel extending from the first lure cavity, wherein the second hook channel is configured to receive a first portion of the weighted hook therein so that a second portion of the weighted hook extends into the lure mold cavity when the first lure die and the complementary second lure die are engaged in face sharing contact with each other, and
wherein the lure mold further comprises a hook retainer configured to retain the weighted hook in a fixed position within the lure mold cavity when the first lure die and the complementary second lure die are engaged in face sharing contact with each other.

2.) The mold apparatus of claim 1, wherein the first lure surface of the first lure die further includes a hook point relief area configured to receive a pointed end of the weighted hook therein, wherein the second hook channel extends between the hook point relief area and the first lure cavity, wherein the hook retainer comprises a retaining member extending outwardly from a surface of the hook point relief area and a head extending radially outward from the retaining member, and wherein a space disposed between the surface of the hook point relief area and the head of the hook retainer is sized to receive a third portion of the weighted hook therein.

3.) The mold apparatus of claim 1, wherein the first lure surface of the first lure die further includes a hook point relief area configured to receive a pointed end of the weighted hook therein, wherein the second hook channel extends between the hook point relief area and the first lure cavity, wherein the hook retainer comprises a fastener configured to removably secure the pointed end of the weighted hook in a fixed position within the hook point relief area.

4.) The mold apparatus of claim 3, wherein the fastener is a threaded bolt with male threads, and wherein the hook point relief area has a threaded opening with female threads that are compatible with the male threads of the bolt.

5.) The mold apparatus of claim 4, wherein the second lure surface of the second lure die further includes a bolt head relief area configured to receive a head of the bolt therein.

6.) The mold apparatus of claim 1, wherein the first lure die has a vent opening extending entirely through the first lure die, wherein the vent opening is disposed adjacent to an upper end of the first lure cavity when the first lure die is in an upright vertical position, wherein a vent channel fluidly connects the first lure cavity to the vent opening.

7.) The mold apparatus of claim 1, wherein the first weight die and the complementary second weight die are pivotally attached to each other by a hinge configured to move the weight mold between an opened position and a closed position, wherein the first weight die and the complementary second weight die are engaged in face sharing contact with each other when the weight mold is in the closed position.

8.) The mold apparatus of claim 7, wherein the hinge comprises a stopper configured to limit pivotal rotation of the first weight die relative to the complementary second weight die such that the first weight die and the complementary second weight die are generally at a 180-degree angle to each other when the weight mold is in the opened position.

9.) The mold apparatus of claim 7, wherein the weight mold further comprises a handle mounted on each of the first weight die and the complementary second weight die, wherein the handle is configured to allow a user to manually retain the weight mold in the closed position.

10.) A portable mold apparatus for making a weighted fishing lure, said mold apparatus comprising:
a weight mold defining a weight mold cavity, wherein the weight mold is configured to mold a metal weight onto an unweighted wireform to form a weighted wireform including a molded weight; and
a lure mold defining a lure mold cavity, wherein the lure mold is configured to receive the weighted wireform within the lure mold cavity and to mold a polymer material around the molded weight of the weighted wireform,
wherein the weight mold comprises a first weight die and a complementary second weight die, wherein the first weight die has a first weight surface that defines a first weight cavity, wherein the second weight die has a second weight surface that defines a second weight cavity, wherein the weight mold cavity is defined by the first weight cavity and the second weight cavity when the first weight die and the complementary second weight die are engaged in face sharing contact with each other, wherein the weight mold includes a liquid metal flow channel that fluidly connects the weight mold cavity to an opening on an exterior of the weight mold,
wherein the weight mold further includes a wire channel extending from the first weight cavity, wherein the wire channel is configured to receive a first portion of the unweighted wireform therein so that a second portion of the unweighted wireform extends into the weight mold cavity when the first weight die and the complementary second weight die are engaged in face sharing contact with each other,
wherein the lure mold comprises a first lure die and a complementary second lure die, wherein the first lure die has a first lure surface that defines a first lure cavity, wherein the second lure die has a second lure surface that defines a second lure cavity, wherein the lure mold cavity is defined by the first lure cavity and the second lure cavity when the first lure die and the complementary second lure die are engaged in face sharing contact with each other, wherein the lure mold includes a polymer flow channel that fluidly connects the lure mold cavity to an opening on an exterior of the lure mold,
wherein the lure mold further includes a plurality of wire retaining channels extending from the first lure cavity, wherein the plurality of wire retaining channels is configured to receive respective retaining portions of the weighted wireform therein so that the weighted wireform extends from each of the plurality of wire retaining channels into the lure mold cavity when the first lure die and the complementary second lure die are engaged in face sharing contact with each other, and
wherein the plurality of wire retaining channels is configured to retain the weighted wireform in a fixed position within the lure mold cavity when the first lure die and the complementary second lure die are engaged in face sharing contact with each other.

11.) The mold apparatus of claim 10, wherein each respective one of the wire retaining channels of the plurality of wire retaining channels forms a loop channel that extends from the first lure cavity and back to the first lure cavity.

12.) The mold apparatus of claim 10, wherein the first lure die has a vent opening extending entirely through the first lure die, wherein the vent opening is disposed adjacent to an upper end of the first lure cavity when the first lure die is in an upright vertical position, wherein a vent channel fluidly connects the first lure cavity to the vent opening.

13.) The mold apparatus of claim 10, wherein the first weight die and the complementary second weight die are pivotally attached to each other by a hinge configured to move the weight mold between an opened position and a closed position, wherein the first weight die and the complementary second weight die are engaged in face sharing contact with each other when the weight mold is in the closed position.

14.) The mold apparatus of claim 13, wherein the hinge comprises a stopper configured to limit pivotal rotation of the first weight die relative to the complementary second weight die such that the first weight die and the complementary second weight die are generally at a 180-degree angle to each other when the weight mold is in the opened position.

15.) The mold apparatus of claim 13, wherein the weight mold further comprises a handle mounted on each of the first weight die and the complementary second weight die, wherein the handle is configured to allow a user to manually retain the weight mold in the closed position.

16.) A method of making a weighted fishing lure, said method comprising the steps of:
providing portable mold apparatus comprising:
a weight mold defining a weight mold cavity, wherein the weight mold is
configured to mold a metal weight onto an unweighted hook to form a weighted hook including a molded weight, and
a lure mold defining a lure mold cavity, wherein the lure mold is
configured to receive the weighted hook within the lure mold cavity and to mold a polymer material around the molded weight of the weighted hook,
wherein the weight mold comprises a first weight die and a
complementary second weight die, wherein the first weight die has a first weight surface that defines a first weight cavity, wherein the second weight die has a second weight surface that defines a second weight cavity, wherein the weight mold cavity is defined by the first weight cavity and the second weight cavity when the first weight die and the complementary second weight die are engaged in face sharing contact with each other, wherein the weight mold includes a liquid metal flow channel that fluidly connects the weight mold cavity to an opening on an exterior of the weight mold,
wherein the weight mold further includes a first hook channel extending
from the first weight cavity, wherein the first hook channel is configured to receive a first portion of the unweighted hook therein so that a second portion of the unweighted hook extends into the weight mold cavity when the first weight die and the complementary second weight die are engaged in face sharing contact with each other,
wherein the lure mold comprises a first lure die and a complementary
second lure die, wherein the first lure die has a first lure surface that defines a first lure cavity, wherein the second lure die has a second lure surface that defines a second lure cavity, wherein the lure mold cavity is defined by the first lure cavity and the second lure cavity when the first lure die and the complementary second lure die are engaged in face sharing contact with each other, wherein the lure mold includes a polymer flow channel that fluidly connects the lure mold cavity to an opening on an exterior of the lure mold,
wherein the lure mold further includes a second hook channel extending
from the first lure cavity, wherein the second hook channel is configured to receive a first portion of the weighted hook therein so that a second portion of the weighted hook extends into the lure mold cavity when the first lure die and the complementary second lure die are engaged in face sharing contact with each other, and
wherein the lure mold further comprises a hook retainer configured to
retain the weighted hook in a fixed position within the lure mold cavity when the first lure die and the complementary second lure die are engaged in face sharing contact with each other;
positioning the first portion of the unweighted hook within the first hook channel;
engaging the first weight die and the second weight die in face sharing contact to
form the weight mold cavity so that the second portion of the unweighted hook extends into the weight mold cavity;
injecting a liquid metal into the weight mold cavity through the opening on the
exterior of the weight mold and allowing the liquid metal to cool and harden to form the weighted hook including the molded weight;
removing the weighted hook from the weight mold;
positioning the first portion of the weighted hook within the second hook
channel;
removably securing the weighted hook in a fixed position relative to the first lure
die;
engaging the first lure die and the second lure die in face sharing contact to form
the lure mold cavity so that the second portion of the weighted hook extends into the lure mold cavity;
injecting a polymer into the lure mold cavity through the polymer flow channel
and allowing the polymer to cure and harden to form the weighted fishing lure with the molded weight of the weighted hook disposed within an interior of a body of the weighted fishing lure; and
removing the weighted fishing lure from the lure mold.

17.) The method of claim 16, wherein the first lure surface of the first lure die further includes a hook point relief area configured to receive a pointed end of the weighted hook therein, wherein the second hook channel extends between the hook point relief area and the first lure cavity, wherein the hook retainer comprises a fastener configured to removably secure the pointed end of the weighted hook in a fixed position within the hook point relief area, wherein the step of removably securing the weighted hook in a fixed position relative to the first lure die comprises using the fastener to removably secure the pointed end of the weighted hook in a fixed position within the hook point relief area.

18.) The method of claim 17, wherein the fastener is a threaded bolt with male threads, wherein the hook point relief area has a threaded opening with female threads that are compatible with the male threads of the bolt, and wherein the step of using the fastener to removably secure the pointed end of the weighted hook in a fixed position within the hook point relief area comprises threading the bolt into the threaded opening to removably secure the pointed end of the weighted hook.

19.) The method of claim 18, wherein the second lure surface of the second lure die further includes a bolt head relief area configured to receive a head of the bolt therein, wherein the step of engaging the first lure die and the second lure die in face sharing contact to form the lure mold cavity comprises engaging the first lure die and the second lure die such that the bolt head is received within the bolt head relief area.

20.) The method of claim 16, wherein the first lure die has a vent opening extending entirely through the first lure die, wherein the vent opening is disposed adjacent to an upper end of the first lure cavity when the first lure die is in an upright vertical position, wherein a vent channel fluidly connects the first lure cavity to the vent opening, and wherein the step of injecting a polymer into the lure mold cavity through the polymer flow channel comprises allowing material contained within the lure mold cavity to vent through the vent channel and the vent opening.
